(19) United States
(12) Patent Application Publication
(10) Pub. No.: US 2006/0224688 A1
(43) Pub. Date: Oct. 5, 2006

(54) System and method for utilizing a presence service to facilitate access to a service or application over a network

(76) Inventor: Robert P. Morris, Raleigh, NC (US)

Correspondence Address: SCENERA RESEARCH, LLC, 111 Corning Road, Suite 220, Cary, NC, 27511, US

(21) Appl. No.: 11/096,764

(22) Filed: Mar. 31, 2005

(51) Int. Cl. G06F 15/16

(52) U.S. Cl. 709/217

(57) ABSTRACT

A system and method for allowing a remote client to have access to a service or application over a network is described. In one version, the method includes registering the service with a presence service on the network and providing information related to the service from the presence service to the remote client. The method also includes allowing the remote client to submit a request to access the service and permitting the remote client to access the service over the network.

### CROSS-REFERENCE TO RELATED APPLICATIONS

The present application is related to co-pending U.S. patent application Ser. No. 10/960,365, entitled “SYSTEM AND METHOD FOR UTILIZING CONTACT INFORMATION, PRESENCE INFORMATION AND DEVICE ACTIVITY,” and co-pending U.S. patent application Ser. No. 10/960,135, entitled “SYSTEM AND METHOD FOR UTILIZING CONTACT INFORMATION, PRESENCE INFORMATION AND DEVICE ACTIVITY,” both filed on Oct. 6, 2004, and both assigned to the assignee of the present application. The present application is also related to co-pending U.S. patent application Ser. No. 10/900,558, entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576, entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application.

### FIELD OF THE INVENTION

The present invention relates to a presence service and more particularly to a method and system for utilizing a presence service to facilitate access to services over a network.

### BACKGROUND OF THE INVENTION

An electronic device, such as a personal computer, typically has access to a plurality of services that enhance the functionality of the device. For example, such services can include a printer service, a camera service, a file system access service, a web service, and applications, such as a photosharing web application, other web applications, etc., which use the services. The various services and applications can be available to the device internally or through an Intranet or LAN (local network). The local network typically is coupled to an external network, such as the Internet. Oftentimes, the local network and the services, are behind at least one firewall, which protect the local network, device and the various services from unwanted external network intruders attempting to infiltrate the local network.

In general, the services are available only to the device(s) coupled to the local network. Devices that are not coupled to the local network do not typically have access to the services. This is particularly true if the services are behind a firewall.

Systems have been developed to enable devices to share specific services and applications with or without firewalls. For example, a peer-to-peer (P2P) file-sharing system allows file-sharing between devices in a secure environment and an instant messaging (IM) system allows real time communication between devices. In the P2P file-sharing system, a user of a first device can view files residing on another device so long as both devices are part of the P2P network. The user can view, select and retrieve a file that resides on another device. In the IM system, a user of a first device logs on to a presence service via an IM client in the first device and is able to initiate a real time chat session with other users/devices that are also logged on via their respective IM clients.

While these types of systems are useful, a drawback is that they are application specific. For example, the IM system is specific to real time text messaging, and P2P file-sharing is specific to the sharing of files. Because the systems are application specific, access to a particular application or service is ad hoc. A unified security system for accessing the services does not exist because each service is accessed in an application specific manner.

Accordingly, there is a need for a method and system that allows a remote client to have access to any available service over a network. The method and system should provide access to a service through a common set of interfaces, and should ensure that the access is secure for both the receiver of the service and the provider of the service. The method and system should also facilitate access through firewalls. The present invention addresses this and other needs.

### SUMMARY OF THE INVENTION

The present invention provides a method and system for providing access to a service or application by a remote client over a network. In one version, the method includes registering the service with a presence service on the network and providing information related to the service from the presence service to the remote client. The method also includes allowing the remote client to submit a request to access the service and permitting the remote client to access the service over the network.

In another version, a system for allowing a remote client in a requesting device to have access to a service or application on a serving device over a network includes a presence service connected to the network for registering the service and the remote client and for storing information related to the remote client and information related to the service. The system also includes a requesting device comprising a communication client for connecting to the network, a watcher user agent for displaying to a remote client services or applications that the remote client is authorized to use over the network, requestor user agents coupled to the communication client for processing the remote client's request for access to one of the services, and a requester coupled to the requestor user agents for sending the request to, and for receiving and processing a result from, the service. The system also includes a serving device comprising a plurality of services, a service user agent associated with each service that translates a request directed to the associated service so that the service can process the request, at least one serventity for receiving the request from the network, routing the request to the service user agent associated with the requested service and returning a result generated by the requested service to the requesting device.

### DESCRIPTION OF SEVERAL VIEWS OF THE DRAWINGS

FIG. 1 is a block diagram of a system for sharing services according to a version of the present invention.

FIG. 2 is a flowchart of a method of providing access to a service or application according to a version of the present invention.

FIG. 3A and FIG. 3B are flowcharts of methods of registering a service according to a version of the present invention.

FIG. 4 is a block diagram of an exemplary device according to a version of the present invention.

FIG. 5 is an illustration of an exemplary user interface according to a version of the present invention.

FIG. 6 is a sequence diagram illustrating a method of allowing a remote client to access a service according to a version of the present invention.

### DETAILED DESCRIPTION OF THE INVENTION

The present invention relates to a presence service and more particularly to a method and system for utilizing a presence service to facilitate access to services over a network. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

According to a version of the present invention, a method and system is provided that allows a remote client in a requesting device to determine any services that are available to a device to which the remote client has access. The method and system allows the remote client to determine the status or availability of each service, and allows the service to be accessed securely even when the service is behind at least one firewall.

In one version, the method and system of the present invention is based on an instant messaging service framework. Instant messaging (IM) is a well known mechanism for allowing real time communication between a first device and a second device over a network. Unlike other conventional methods of communication between client devices, e.g., electronic mail, IM provides a direct communication pipeline between the first and second devices so that a message is received and displayed in real time, i.e., as it is being entered in by a first user of the first client device. In addition to exchanging real time text messages, IM also permits real time sharing of other types of data, such as for example, static files and active content on a user's device.

As stated above, IM is an application specific arrangement for sharing a communication service. Such communication is facilitated by a presence service, which resides in a server coupled to the network. The presence service collects and stores data, known as presence information, associated with users of the IM service, i.e., presence service clients. The presence service uses the presence information in a known manner to authenticate and authorize clients so that communication between clients via the IM service are secure. If a user's device is behind a firewall, the presence service facilitates access through the firewall.

More information on IM, presence services, and presence information can be found at the jabber.org/jeps site. For example documents jep-0132.html, and jep-0119.html are of interest. In addition, the ieff.org site contains internet related documents related to presence information and IM. Such documents include draft-ietf-impp-cpim-pidf-08.txt in the internet-drafts section of the ieff.org site, as well as rfc2778.txt and rfc2779.txt in the rfc section of the ieff.org site.

According to a version of the present invention, the presence service is used to facilitate access to services associated with a presence service client by other presence service clients. In one version, presence service clients are not limited to human users. Rather, presence service clients also include devices, components and even the services themselves. Thus, services can be accessed by users and/or devices, components, and other services.

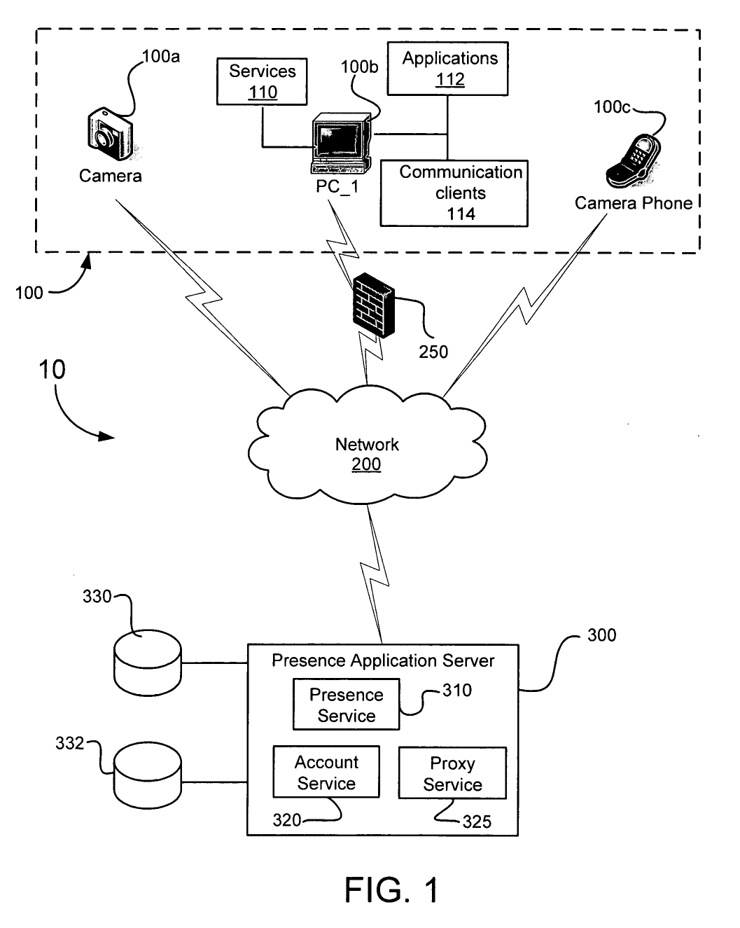

FIG. 1 is a schematic block diagram of a system according to a version of the present invention. Client devices 100a, 100b, 100c, collectively referred to as devices 100, communicate with one another through a network 200, such as the Internet. According to a version of the present invention, at least one device, e.g., the personal computer 100b, has access to a plurality of services 110, applications 112 and communication clients 114. For example, services 110 can include printing, file system access, local database access, and web server, applications 112 can include web-based applications, and communication clients 114 can include IM/chat, phone, electronic mail, and MMS. While the devices 100 depicted in FIG. 1 are typical devices used to access the network 200, other types of devices 100 could be used, such as a PDA for example. Typically, a device 100b can be protected by at least one firewall 250.

The system 10 includes a presence application server 300 that is accessible by the devices 100 through the network 200. The presence application server 300 includes the presence service 310, an account service 320 and a proxy service 325. In a preferred embodiment, the presence service 310 manages, e.g., receives, stores, updates and provides, global presence information for the presence service clients, e.g., user(s) of a device 100a, 100b, 100c, devices 100, services 110, applications 112, communication clients 114 and other components.

Presence information typically includes the presence service client's status, an optional activity address, and other information relating to each client. For example, the status of a client, e.g., a user, can simply be “open” or “closed,” indicating whether the user is available. Other examples of the client's status can include “online”, “away from my desk”, “stepped out”, or “on the phone.” The presence information for a presence service client can also include contact information, which includes contact addresses at which the client can be reached. The contact addresses can include MMS, email, postal addresses, ftp addresses, phone number(s), facsimile numbers and other mechanisms available for reaching a particular client, as well as contact priorities.

The presence information is preferably stored in a presence data storage structure 330, such as a database, that is in communication with the presence application server 300. The presence information is preferably in the form of a presence tuple for each presence service client. Typically, the presence tuple is a structured format that fully describes and defines the presence information associated with the client. For example, the presence tuple can be part of a structured document using XML. Although the presence data storage structure 330 is depicted as having a particular location remote from the devices 100, nothing prevents the storage structure 330 from being stored in another location. For example, all or a portion of the presence information may be stored in a memory structure (not shown) on the devices 100 or on another memory structure (not shown).

The account service 320 in the presence application server 300 manages client accounts and information related to clients other than presence information. For example, such client related information can include a user-defined list of preferred contacts that can include friends, relatives, co-workers, etc., commonly referred to as a “friends list,” and authentication information and authorization data for each contact on the list.

The client related information is preferably stored in a friends data storage structure 332, such as a database, that is in communication with the presence application server 300. Alternatively, the storage structure 332 can be located elsewhere. For example, all or a portion of the client related information may be stored in a memory structure (not shown) on the devices 100 or on another memory structure (not shown).

The friends data storage structure 332 is shown separately from the presence information data storage structure 330 for the sake of clarity. Those with ordinary skilled in the art would readily appreciate that the presence information and client related information can be stored separately or in the same data structure.

The proxy service 325 associated with the presence application server 300 serves as a proxy among the devices 100 in the network 200. The proxy service 325 permits the devices 100 to communicate with one another through a firewall 250 in a known manner. The proxy service 325, while shown in the presence application server 300 can reside in a separate server (not shown) or with the presence service 310.

According to a version of the present invention, the presence service 310 facilitates secure access to services 110 and applications 112 to authorized users or devices, e.g., 100a, by providing information to the device 100a so that the user of the device 100a can determine which services 110 and applications 112 he or she is authorized to use and select a desired service 110 or application 112 to use.

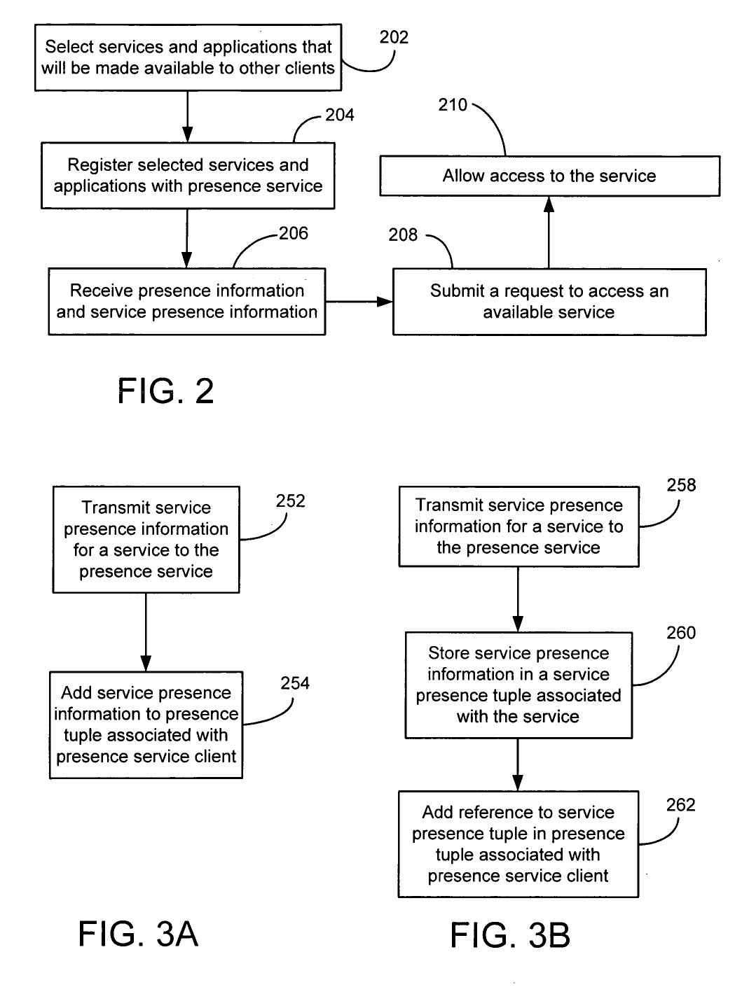

FIG. 2 is a high-level flowchart of a method for providing access to services behind a firewall according to a version of the present invention. Referring to FIG. 1 and FIG. 2, a user of a serving device, e.g., 100b, selects which services 110 and applications 112 to make available to other presence service clients (step 202). The services 110 and applications 112 to be made available are then registered with the presence service 310 (step 204).

FIG. 3A and FIG. 3B are flowcharts of methods for registering a service (or application) according to versions of the present invention. Referring first to FIG. 1 and FIG. 3A, presence information related to a service 110 (or application 112) is transmitted to the presence service 310 (step 252). Such information, referred to as service presence information, can include a name or other identifying information of the service 110, and contact information specifying how to access the service 110, e.g., protocol required, optional parameters, and address information. Optionally, the service presence information can include information relating to suitable communication clients 114 for interaction with the service 110, security policies specific to the service 110, and billing/tracking policies for a fee based service 110.

The service presence information is added to a presence service client's (e.g., a user of the serving device 100b and/or the serving device 100b itself) presence tuple (step 254), such that the service 110 or application 112 is closely associated with the presence service client. Thus, the presence tuple is extended to include the service presence information. This version is particularly useful when the service 110 is closely associated with the presence service client.

Referring now to FIG. 1 and FIG. 3B, an alternative method for registering the service 110 (or application 112) includes transmitting the service presence information for the service 110 to the presence service 310 (step 258) and storing the service presence information in a separate presence tuple, referred to as a service presence tuple (step 260). One or more presence service clients can then register as part of their respective presence tuples a reference to the service presence tuple (step 262). This version is particularly useful if the service 110 (or application 112) is associated with more than one presence service client. Because the reference to the service tuple will typically be smaller than the service presence information associated with the service, storage space can be conserved. Moreover, this version can provide more flexibility in defining a service 110. In particular, a service presence tuple for a service 110 can have a reference to another service presence tuple for another service 110. For instance, a photo-sharing service 110 can make a reference to a particular print service 110 suitable for printing images by registering as part of its service presence tuple a reference to the print service presence tuple.

Referring again to FIG. 2, once the services 110 and applications 112 are registered with the presence service 310 (step 204), the presence service 310 can provide to the requesting device 100a (FIG. 1) a friends list for a user of the device 100a and/or a friends list for the device 100a. The friends list(s) includes presence information for contacts on the friends list(s) along with the service presence information for services 110 and applications 112 associated with the contacts.

Once the presence information and service presence information is received and displayed by the requesting device 100a (step 206), a requesting entity, referred to as the “remote client,” can then submit a request to access an available service 110 (step 208). While the remote client is typically the user of the device 100a, nothing prevents the remote client from being the device itself 100a, a component (not shown) in the device 100a, or another service 110 running on the device 100a. Because the remote client is already authorized via the friends list, the remote client is allowed to access the service 110 (step 210).

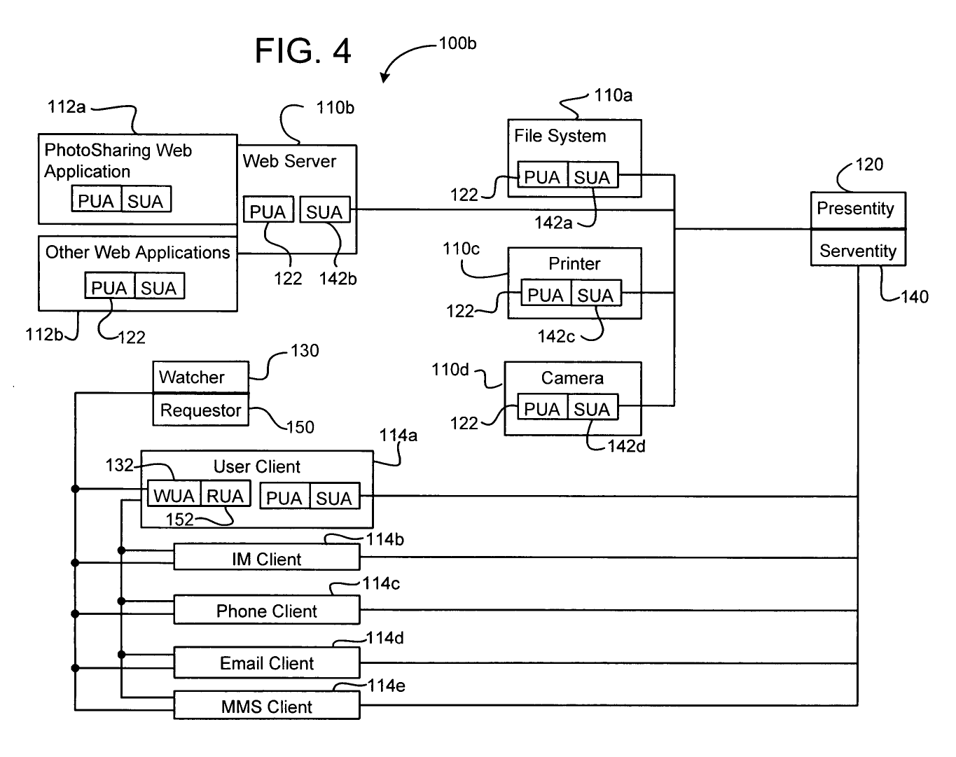

FIG. 4 is a block diagram of an exemplary device, e.g., 100b, according to a version of the present invention. In this example, the client device 100b is a personal computer that has access to a plurality of services 110a-110d and applications 112a, 112b. For example, the device 100b has access to a file system access service 110a, a web server service 110b, a printer service 110c, a camera service 110d, a photosharing web application 112a and other web applications 112b. The services 110a-110d and applications 112a, 112b are behind a firewall 250 (FIG. 1). The present invention is not limited to the services and applications shown; rather, the present invention can include additional services depending on the type of client device 100 used.

The client device 100b also includes a plurality of communication clients 114a-114e through which a user of the device 100b can be represented to the presence service 310 (FIG. 1). For example, the device 100b can include a user client 114a, an IM/Chat client 114b, a phone client 114c, an email client 114d and an MMS client 114e.

The device 100b includes at least one presentity 120. The presentity 120 sends presence information and service presence information reflecting the status of each presence service client, e.g., the device 100b and the services 110, the applications 112, and the communication clients 114 (collectively referred to as “device components”), to the presence service 310 via the network 200 (FIG. 1). The presentity 120 can be an independent module (as shown) or it can be a module integrated in each device component 110, 112, 114, or a combination of both.

Each device component 110, 112, 114 has access to a presence user agent (PUA) 122 that serves as an interface between the component 110, 112, 114 and the presentity 120. For example, a user of the device 100b can enter presence information concerning him/herself through the PUA 122 in the user communication client 114a. In another version, the PUA 122 can be an external service used by or acting on behalf of a device component. The PUA 122 can be customized for a presence service client, or it can be a standardized module that can handle several presence service clients.

The device 100b includes at least one watcher 130 that is in communication with the plurality of communication clients 114a-114e. The watcher(s) 130 receive presence information and service presence information from the presence service 310. The presence information and service presence information received typically is associated with other devices 100 and/or users in the network 200, such as contacts on the user's friends list. Watchers 130 come in several varieties. Two common varieties are (1) fetchers, which request (i.e., pull) presence information as needed, and (2) subscribers, which subscribe to events related to presence tuple additions, deletions, updates, and other alterations.

The presence information and service presence information received by the watcher 130 is interpreted by a watcher user agent 132 (WUA), which provides an interface to display the presence and service presence information for each communication client 114a-114e. As with presentities 120 and PUAs 122, watchers 130 and WUAs 132 may be integrated with each communication client 114a-114e or may be an external service used by or acting on behalf of the communication clients 114a-114e. The WUA 132, like the PUA 122, can be customized for a communication client 114a, or it can be a standardized module that can handle several communication clients 114a-114e.

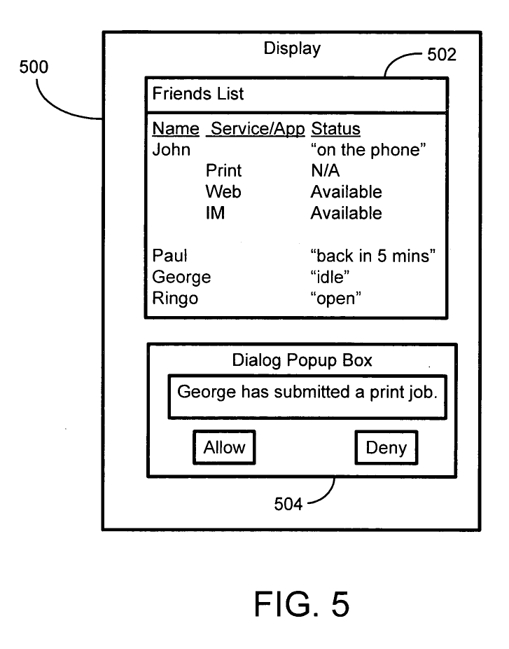

FIG. 5 is an illustration of an exemplary user interface provided by the WUA 132 according to a version of the present invention. The display 500 includes a friends list 502 associated with the user of the user client 114a (FIG. 4). In this version, the friends list 502 provides the name of each contact on the list, available services associated with each contact, and the status of the friend and the associated available services. Other presence and service presence information can be included in the friends list 502, such as contact information. In addition, the friends list 502 can include stand alone client devices 100 (not shown) that make services 110 and applications 112 available to authenticated users through the presence service 310. In this manner, the user, via the user client 114a, can determine which services 110 and applications 112 are available on a particular friend's device 100, and select a service 110.

According to a preferred version of the present invention, the device 100b includes at least one requestor 150. The requestor 150 receives a request to access a service 110 associated with a friend through a requestor user agent (RUA) 152. When a service 110 is selected from the friends list 502, the RUA 152 provides an appropriate interface with the user for making a request, i.e., it translates and enables the user to provide an appropriate request for the service 110. In a preferred embodiment, the RUA 152 can be customized according to the service 110 selected. The requestor 150 receives the request from the RUA 152 and directs it to the appropriate serving device 100, either directly or via the presence service 310.

The device 100b includes at least one serventity 140 for receiving the request from a requestor 150. Depending on the circumstances, the serventity 140 can receive the request directly from the requestor 150 or indirectly via the presence service 310 or proxy service 325. The serventity 140 routes the request to a service user agent (SUA) 142c associated with the requested service 110, e.g., the printer service 110c. The SUA 142c translates the request into a format understood by the associated service 110c. If the requested service provides a response, e.g., a web server service 110b serving a web page, the SUA 142 and serventity 140 route the response back to the requestor 150, either directly or via the presence service 310 or proxy service 325. In one version, one SUA 142 can be used to translate requests for several services 110 or applications 112.

In FIG. 4, the presentity 120 and serventity 140 are integrated together, as are the PUAs 122 and SUAs 142a-142d. Similarly, the watcher 130 is integrated with the requestor 150 and the WUA 132 is integrated with the RUA 152. These pairings are logical because services 110 and applications 112 utilize the serventity 140 and SUA 142a-142d to receive and respond to requests for access, and utilize the presentity 120 and PUA 122 to provide service presence information to the presence service 310. The communication clients 114a-114e utilize the watcher 130 and WUA 132 to receive and display presence and service presence information and utilize the requestor 150 and RUA 152 to make a request for access to a service displayed. Alternatively, the presentity 120, serventity 140, watcher 130 and requester 150 can be implemented separately.

In a preferred embodiment, it is not necessary to modify any of the services 110, applications 112 and communication devices 114 in order to implement the present invention. The user agents, e.g., PUA 122, WUA 132, SUA 142 and RUA 152, allow the services 110, applications 112, and communication clients 114 to plug-in to the presentities 120, watchers 130, serventities 140 and requesters 150. Because interaction with the presence service 310 can be achieved without modifying the services 110, applications 112 and communication clients 114 on a device 100b, the present invention provides a broad platform for making any services 110 and applications 112 available to a remote client.

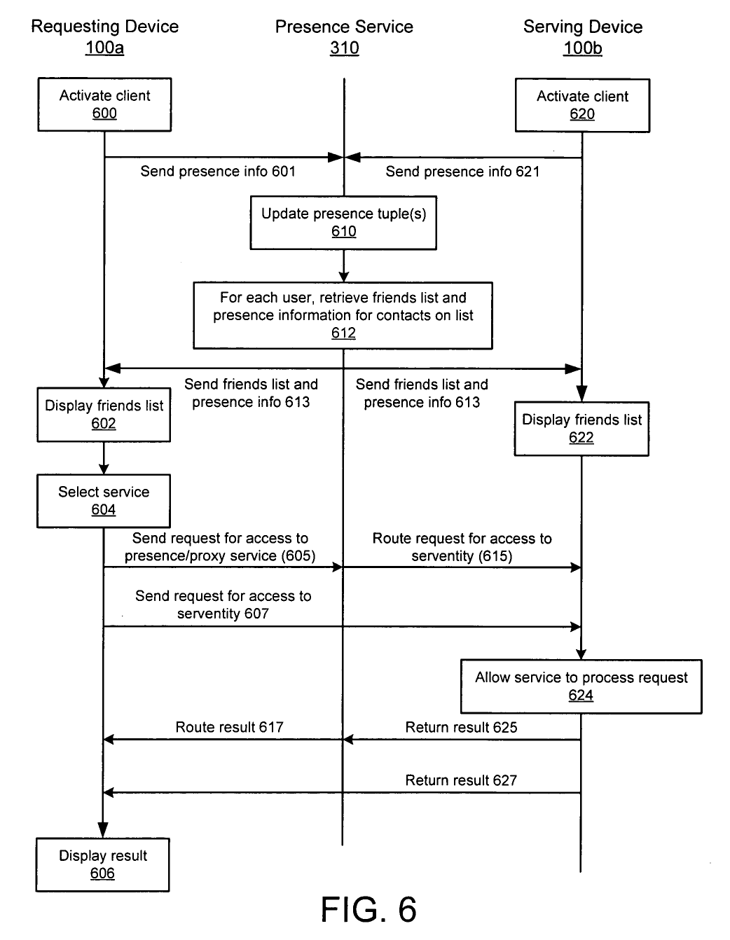

FIG. 6 is a sequence diagram for a method of accessing a service by a remote client according to a version of the present invention. Referring to FIG. 1, FIG. 4 and FIG. 6, a user (remote client) of a requesting (remote) device activates a communication client 114 (step 600) therein and a user of a serving device activates a communication client 114 (step 620) therein so that both the requesting device and the serving device are connected to the network 200. For example, the requesting device can be the camera 100a and the serving device can be the computer 100b, both of which have activated their respective user communication clients 114a. Once activated, the respective PUAs 122 collect presence and service presence information from the users and various device components (110, 112, 114) and use the respective presentites 120 to send the collected information to the presence service 310 (steps 601, 621).

For each device 100a, 100b, the presence service 310 receives the associated presence and service presence information and updates the relevant presence tuple(s) associated with the user, the device 100a, 100b, and/or associated services 110 and applications 112 (step 610). The presence service 310 then retrieves the friends list associated with the user and/or device, and the current presence and service presence information for the contacts on each list (step 612). The presence service 310 then provides the retrieved list(s) and presence and service presence information to the appropriate device 100a, 100b (step 613). In one version, the presence service 310 pushes the presence and service presence information to the devices 100a, 100b. Alternatively, the presence and service presence information can be pulled from the presence service 310.

In each device 100a, 100b, the watcher 130 receives the friends list(s) and presence/service presence information and the WUA 132 displays the friends list(s), which preferably includes the associated services and applications, and the status of each (step 602, step 622). At this point, the users can see who of their friends is connected to the network 200 and what services 110 and applications 112 are available.

The requesting user (remote client) selects a service 110, such as the printer service 110c, associated with the serving user and/or the serving device 100b (step 604). The RUA 152 in the requesting device 100a receives the selection, initiates any additional software needed to process the request, and sends the request to the requester 150, which sends the request to the presence service 310 or proxy service 325 (step 605). The presence service 310 or proxy service 325 receives the request from the requester 150 in the requesting device 100a and routes the request to the serving device 100b (step 615). If the serving device 100b is behind a firewall 250 (FIG. 1), the request can be routed to the proxy service 325 associated with the presence application server 300, which routes the request through the firewall 250 to the serving device 100b. Alternatively, if a firewall 250 is not present, the requestor 150 can send the request directly to the serving device 100b (step 607) using the service presence information related to the service 110.

At the serving device 100b, the serventity 140 receives the request and routes the request to the SUA 142c associated with the requested service 110c. The SUA 142c translates the request into a format understood by the associated service 110c. In one version, the SUA 142c can display a pop up dialog window 504 (FIG. 5) informing the serving user that the remote client has made a request to access the service 110c, and asking the serving user to allow or deny access. Once the request is translated and authorized, the service 110c processes the request (step 624).

Depending on the service requested, the associated SUA 142 can simply route the request directly to the service 110. For example, if the request is one to access the serving device's 100b web server 110b, the SUA 142b can simply route the URL request to the local address of the web server 110b and route any response directly to the requesting device 100a. If the service 110b is accessible through a public IP address, which is included in the service presence information associated with the service 110b, the SUA 142b can redirect the request so that it is sent directly to a service port in the service 110b. Redirection may be initiated by the SUA 142b or it may be determined by the requesting device 100a. The ability to redirect the request allows a serving device 100b to advertise a service 110 that is not resident on the serving device 100b itself or even on the same network. For example, a user can advertise a print service 110c through the user's presence tuple where the location of the printer is fixed (e.g., at home). In this way, the user can have all print requests routed to the user's home printer regardless of the user's physical location.

If a result is produced by the service 110b, the serventity 140 returns the result to the presence service 310 or proxy service 325 (step 625), which in turn routes the response to the requesting device 100a (step 617) or returns the result directly to the requesting device 100a (step 627). The requestor 150 receives the result and uses the RUA 152 to display the result to the remote client (step 606).

To provide further clarity, the following example illustrates an exemplary exchange between two users, Anna and Andy, using a preferred version of the present invention.
Anna and Andy are both online and are on each other “Friends List”. Anna wants to communicate with Andy.
Anna can tell from her user interface that Andy is online, that Andy's IM service is not available, but that Andy's phone service is available.
Anna initiates a phone call to Andy, which Andy accepts, and they talk.
Anna mentions some recent pictures she has taken, which Andy would like to see. He sees from his user interface that Anna's machine is running a web server and that the web photo sharing application is available. Note that web application does not need to be active in order for it to be available.
Andy, as the remote client, selects Anna's photo sharing web application to initiate a browsing session.
Anna receives a message that Andy is trying to access her photo sharing web application, and is given the opportunity to grant or deny the request. Alternatively, Anna could have preconfigured the access settings in her friends list to automatically allow Andy access.
Andy's request is granted and the home page of Anna's photo sharing web application is displayed in Andy's browser.
They chat while Andy browses. Andy is allowed to control the web application independent from Anna.
Andy sees a picture he likes, but Anna's photo sharing application does not allow downloads of original images.
Andy asks Anna to print an 8×10 copy of the image on Andy's printer.
Anna opens the image in her favorite viewing software. She opens the print dialog and selects Andy's printer which the print subsystem has detected as available through a print subsystems WUA. She sets the settings and layout and submits the image for printing. In this instance, Anna is the remote client.
The image is spooled to Andy's printer for printing. A message pops up on Andy's machine indicating Anna wants to print a picture, and describes the characteristics of the print job, e.g., “image”. He has the option to change the settings.
Andy loads photographic paper into his printer, then authorizes the print request.

According to aspects of the present invention, access to services and applications by a remote client is facilitated by a presence service. In particular, services and applications that are available are registered on the presence service, which stores information related to the services and applications persistently. Information related to the available services and applications is provided to a remote client so that the remote client can determine which services and applications are available, and with whom or what the services and applications are associated. Through aspects of the present invention, the presence service facilitates access to a selected service securely from the standpoint of the requesting user and of the service provider.

The preferred version of the present invention provides a framework that allows services and applications to plug-in to the system, thereby eliminating any need to modify the service or application modules. The framework is not application or service specific, and therefore, any service or application can be made available.

Note that the present application is related to co-pending U.S. patent application Ser. No. 10/960,365, entitled “SYSTEM AND METHOD FOR UTILIZING CONTACT INFORMATION, PRESENCE INFORMATION AND DEVICE ACTIVITY,” and co-pending U.S. patent application Ser. No. 10/960,135, entitled “SYSTEM AND METHOD FOR UTILIZING CONTACT INFORMATION, PRESENCE INFORMATION AND DEVICE ACTIVITY,” both filed on Oct. 6, 2004, and both assigned to the assignee of the present application. The present application is related to co-pending U.S. patent application Ser. No. 10/900,558, entitled “SYSTEM AND METHOD FOR PROVIDING AND UTILIZING PRESENCE INFORMATION,” filed on Jul. 28, 2004, and assigned to the assignee of the present application. The present application is also related to co-pending U.S. patent application Ser. No. 10/903,576, entitled “SYSTEM AND METHOD FOR HARMONIZING CHANGES IN USER ACTIVITIES, DEVICE CAPABILITES AND PRESENCE INFORMATION,” filed on Jul. 30, 2004, and assigned to the assignee of the present application. Consequently, in addition to the components and methods described herein, the system and the methods can be combined with the methods and system described in the above-identified co-pending patent applications.

The present invention is directed to a method and system for utilizing a presence service to facilitate access to services over a network. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A method of allowing a remote client to have access to a service or application over a network, the method comprising:
registering the service with a presence service on the network;
providing information related to the service from the presence service to the remote client;
allowing the remote client to submit a request to access the service; and
permitting the remote client to access the service over the network.

2. The method of claim 1 further comprising allowing the presence service to authenticate and authorize the remote client prior to providing the information related to the service to the remote client.

3. The method of claim 1 wherein registering the service includes transmitting service presence information for the service to the presence service and storing the service presence information persistently at the presence service.

4. The method of claim 3 wherein the service presence information includes a name of the service and contact information specifying how to access the service.

5. The method of claim 3 wherein the service presence information includes security policies for accessing the service.

6. The method of claim 3 wherein storing the service presence information includes extending a presence tuple associated with a presence service client to include the service presence information, wherein the service is associated with the presence service client.

7. The method of claim 3 wherein storing the service presence information includes storing the service presence information in a service presence tuple associated with the service.

8. The method of claim 7 wherein registering the service further includes associating the service with a presence service client by including in a presence tuple associated with the presence service client a reference to the service's service presence tuple.

9. The method claim 1 further comprising displaying information relating to a status for the service indicating whether the service is available in response to the remote client submitting a request to access the service.

10. The method of claim 9 wherein displaying the information includes providing a user interface that includes a friends list associated with the remote client, wherein the friends list includes names of preferred contacts, names of services associated with each preferred contact, and a status for each preferred contact and associated service.

11. The method of claim 10 wherein allowing the remote client to submit a request further includes selecting the service from the friends list.

12. The method of claim 1 further including routing the request from the remote client to the presence service and routing the request from the presence service to the service.

13. The method of claim 1 further including routing the request from the remote client to a proxy service and routing the request from the proxy service through a firewall to the service, thereby permitting access by the remote client to the service behind the firewall.

14. The method according to claim 1 wherein allowing the remote client to submit a request for access includes using the information related to the service to route the request directly from the remote client to the service.

15. A computer readable medium having computer program instructions for allowing a remote client to have access to a service or application over a network, the instructions for:
registering the service with a presence service on the network;
providing information related to the service from the presence service to the remote client;
allowing the remote client to submit a request for access to the service; and
permitting the remote client to have access to the service over the network.

16. The computer readable medium of claim 15 further comprising instructions for allowing the presence service to authenticate and authorize the remote client prior to providing the information related to the service to the remote client.

17. The computer readable medium of claim 15 wherein registering the service includes transmitting service presence information for the service to the presence service and storing the service presence information persistently at the presence service.

18. The computer readable medium of claim 17 wherein the service presence information includes a name of the service and contact information specifying how to access the service.

19. The computer readable medium of claim 17 wherein the service presence information includes security policies for accessing the service.

20. The computer readable medium of claim 17 wherein storing the service presence information includes extending a presence tuple associated with a presence service client to include the service presence information, wherein the service is associated with the presence service client.

21. The computer readable medium of claim 17 wherein storing the service presence information includes storing the service presence information in a service presence tuple associated with the service.

22. The computer readable medium of claim 21 wherein registering the service further includes associating the service with a presence service client by including in a presence tuple associated with the presence service client a reference to the service's service presence tuple.

23. The computer readable medium claim 15 further comprising instructions for displaying information relating to a status for the service indicating whether the service is available in response to the remote client submitting a request to access the service.

24. The computer readable medium of claim 23 wherein displaying the information includes providing a user interface that includes a friends list associated with the remote client, wherein the friends list includes names of preferred contacts, names of services associated with each preferred contact, and a status for each preferred contact and associated service.

25. The computer readable medium of claim 24 wherein allowing the remote client to submit a request further includes selecting the service from the friends list.

26. The computer readable medium of claim 15 further including routing the request from the remote client to the presence service and routing the request from the presence service to the service.

27. The computer readable medium of claim 15 further including routing the request from the remote client to a proxy service and routing the request from the proxy service through a firewall to the service, thereby permitting access by the remote client to the service behind the firewall.

28. The computer readable medium according to claim 15 wherein allowing the remote client to submit a request for access includes using the information related to the service to route the request directly from the remote client to the service.

29. A method of gaining access to a service or application by a remote client over a network, the method comprising:
providing a presence service on the network to store information related to the remote client and information related to the service or application;
receiving in a requesting device, utilized by the remote client, information from the presence service related to the service's status;
allowing the remote client to send a request for access to the service; and
gaining access to the service, wherein the presence service uses the stored information related to the remote client and the service or application to enable the remote client of the requesting device to access the service or application.

30. The method of claim 29 further comprising displaying the information related to the service or application to the remote client by providing a user interface that includes a friends list associated with the remote client, wherein the friends list includes names of preferred contacts, names of services associated with each preferred contact, and a status for each preferred contact and associated service.

31. The method of claim 29 further including providing in the requesting device at least one requestor user agent for processing the request for access to the service or application, and providing in the requesting device a requestor communicatively coupled to the requestor user agent for sending the request and for receiving and processing a result from the service or application.

32. A method of sharing a service or application with a remote client over a network, the method comprising:
providing a presence service on the network to store information related to the remote client and information related to the service or application;
receiving a request from the remote client to use the service or application;
invoking the service or application to process the request; and
returning a result of the request.

33. The method of claim 32 further including:
associating a service user agent with the service or application, wherein the service user agent translates the request so that the service can process the request; and
providing at least one serventity for receiving the request from the remote client and for routing the request to the service user agent associated with the requested service.

34. The method of claim 32 wherein receiving a request includes receiving the request directly from one of the remote client, the presence service, or a proxy service associated with the presence service.

35. A system for allowing a remote client using a requesting device to have access to a service or application on a serving device over a network, the system comprising:
a presence service connected to the network for registering the service and the remote client and for storing information related to the remote client and information related to the service;
a requesting device comprising:
a communication client for connecting to the network;
a watcher user agent coupled to the communication client for displaying to the remote client at least one service or application that the remote client is authorized to use over the network;
a watcher coupled to the watcher user agent and to the presence service for receiving the information related to the at least one service or application;
at least one requestor user agent coupled to the communication client for processing a request for access to one of the services; and
a requestor coupled to the at least one requester user agent for sending the request for access to, and for receiving and processing a result from, the service; and
a serving device comprising:
the at least one service or application;
a service user agent associated with the service or application, wherein the service user agent translates a request directed to the associated service or application so that the service or application can process the request; and
at least one serventity for receiving the request from the network, routing the request to the service user agent associated with the requested service or application and returning a result generated by the requested service or application to the requesting device.

36. A requesting device comprising:
a watcher coupled to a presence service on the network, the watcher for receiving information relating to services or applications available over the network;
a watcher user agent coupled to the watcher for displaying to a remote client at least one service or application that the remote client is authorized to use over the network;
at least one requester user agent for processing a request by the remote client for access to the at least one service or application; and
a requester coupled to the at least one requestor user agent for sending the request for access to and for receiving and processing a result from the service or application.

37. A serving device comprising:
a service or application;
a service user agent associated with the service or application, wherein the service user agent translates a request from a remote client for the associated service or application so that the service or application can process the request; and
at least one serventity for receiving the request, routing the request to the service user agent associated with the requested service or application and returning a result generated by the requested service or application.

38. The serving device of claim 37 further including at least one firewall protecting the serving device and the service or application, wherein the request is received via a proxy service associated with a presence service on the network.
